(19) United States
(12) Patent Application Publication
(10) Pub. No.: US 2002/0185986 A1
(43) Pub. Date: Dec. 12, 2002

(54) Apparatus for driving brushless motor

(76) Inventor: Kunio Seki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/131,265

(22) Filed: Apr. 23, 2002

(30) Foreign Application Priority Data
Jun. 7, 2001 (JP) 2001-172513

(51) Int. Cl. G05B 11/28

(52) U.S. Cl. 318/599

(57) ABSTRACT

A circuit for a three-phase brushless motor, which can change phase stator windings with keeping a predetermined phase difference to a phase of a back electromagnetic force generated in any one of the phase stator windings, even if a number of rotation changes extremely, and thereby which can reduce a change of a torque and always keep the most suitable efficiency in driving. The circuit for the three-phase brushless motor comprises a first counter for checking a time of a cycle of a zero cross of a back electromagnetic force detected by a back electromagnetic force detector, and a second counter for counting the time checked by the first counter at a clock having two times as high a frequency as the first counter, and determines a timing of changing the phase stator windings on the basis of an output outputted from the second counter.

### BACKGROUND OF THE INVENTION

1. Field of the Invention

The invention relates to a controlling technique for driving a multiphase brushless motor and further a sensorless motor, and in particular to a controlling technique for driving a motor so as to reduce a torque ripple and an unevenness of rotation.

2. Description of Related Art

A three-phase brushless motor is frequently used as a main motor of various types of disc apparatuses of a personal computer, a portable AV (audiovisual) apparatus, and other types of OA (office automation) apparatuses, because the three-phase brushless motor is highly efficient in being driven, has a small torque ripple and changes a direction of rotation easily. In recent years, a ratio of a so-called sensorless type motor requiring no position detecting element such as a hall element and so on in the three-phase brushless motor used for the above-described apparatuses is increasing, and a large number of specific ICs for driving the sensorless type motor is put to practical.

The sensorless type motor usually adopts an algorithm of detecting a zero cross timing of a back electromagnetic force generated in a non current-carrying phase of three phases by a back electromagnetic force detector, and changing a path for supplying a current to a stator winding on the basis of the detected zero cross timing, in order to keep rotating.

However, because the relationship between the back electromagnetic force and the torque constant is one to one, that is, the back electromagnetic force and the torque constant have the same phases as each other, there is a phase shift of an electric angle of 30 degrees between the zero cross timing of the back electromagnetic force and the reciprocal cross timing of the torque constants of the three phases. That is, the phase of the zero cross timing of the back electromagnetic force is 30 degrees in advance of the phase of the reciprocal cross timing of the torque constants.

Accordingly, if the current-carrying phase is changed just at the zero cross timing of the back electromagnetic force, the big torque ripple is generated in the sensorless type motor. Specially, in case of a three-phase half-wave drive brushless motor, the torque becomes zero for a moment just after the current-carrying phase is changed. As a result, because not only the torque ripple increases, but also the average torque constant reduces extremely, the efficiency of the three-phase half-wave drive brushless motor in being driven grows worse.

In order to reduce the torque ripple, the controlling technique for driving the sensorless type motor according to an earlier development adopts an algorithm of providing a time constant circuit between the stator winding generating the back electromagnetic force and the back electromagnetic force detector, shifting back the phase of the back electromagnetic force inputted to the back electromagnetic force detector by about 30 degrees, and adjust the zero cross timing of the back electromagnetic force to the reciprocal cross timing of the torque constants.

FIGS. 1A to 1G are timing charts showing a state of signals changing in the circuit for driving the three-phase brushless motor, and the three-phase brushless motor.

FIG. 1A is a timing chart showing back-EMFs (back electromagnetic forces) generated in U-phase, V-phase and W-phase stator windings of the motor. FIG. 1B is a timing chart showing input voltages inputted to the back-EMF detector (the back electromagnetic force detector), the phases of which are shifted by the time constant circuit. FIG. 1C is a timing chart showing a rotational signal RTS generated on the basis of the zero cross timing detected by the back-EMF detector. FIGS. 1D, 1E and 1F are timing charts showing currents for driving the U-phase, V-phase and W-phase stator windings respectively. FIG. 1G is a timing chart showing the torque ripple generated in the motor rotating.

As shown in FIGS. 1A to 1G, it is understood that if the time constant of the time constant circuit is determined so that the phase difference between the back-EMF of each of the stator windings and the input voltage inputted to the back-EMF detector is just 30 degrees, it is possible to reduce the torque ripple to 13% substantially.

Therefore, the method can be applied to the purpose of always rotating the motor with a predetermined number of rotation. However, when the method is applied to the purpose of rotating the motor with a number of rotation which always changes, or of rotating the motor with a predetermined number of rotation which changes according to the type of the motor, the method prevents the circuit for driving the motor from forming an integrated circuit, because the frequency of the back-EMF changes according to the number of rotation of the motor so that it is necessary to adjust the time constant of the time constant circuit.

For example, FIGS. 2A to 2G are timing charts showing a state of signals when the time constant of the time constant circuit provided between the stator windings and the back-EMF detector is the same as the case shown in FIGS. 1A to 1G, and the number of rotation of the motor is half one of the case shown in FIGS. 1A to 1G.

When the number of rotation becomes half, the frequency of the back-EMF also becomes half. That is, when the number of rotation becomes half, the cycle of rotation becomes two times. However, because the input voltage inputted to the back-EMF detector is shifted by the time constant circuit by the same phase, the phase difference between the back-EMF and the torque constant is 15 degrees which is half 30 degrees of case shown in FIG. 1. As a result, the torque ripple increases from 13.3% to 29% extremely.

Further, although it is not shown in figures, it is understood that when the number of rotation becomes one tenth, the torque ripple increases more. Therefore, in the case, the torque ripple gets to about 50%.

FIGS. 3A to 3G are timing charts showing a case wherein another technique for reducing the torque ripple according to an earlier development is applied to the circuit for driving the three-phase brushless motor.

The technique is aiming at that the half cycle of the rotational signal RTS which is the zero cross timing of the back-EMF is an electric angle of 60 degrees, and the timing of the phase difference of 30 degrees is not obtained on the basis of the rotational signal RTS. Therefore, the circuit adopts a VCO (voltage controlled oscillator) and a PLL (phase lock loop). Accordingly, the circuit generates the oscillating signal having four times or two times as high the frequency as the rotational signal RTS, generates the cycle of the electric angle 30 degrees newly, and uses the cycle as the timing at which the phase is changed.

According to the above-described method, in case the lock of the PLL is not opened, even if the number of rotation is changed, it is possible to always obtain the preferable timing at which the phase is changed. However, because the PLL always requires a phase compensating circuit comprising a capacity element and so on in order to keep the stability of the loop thereof certainly, the PLL has many technical difficulties in order to keep the stability of the loop thereof certainly within the large range of more than ten times as large the number of rotation as the case shown in FIGS. 1A to 1G. Further, because the capacity value of the phase compensation have to be greater as the range of the number of rotation becomes larger, there occurs the problem that the following becomes worse and the torque ripple becomes bigger, when the number of rotation is changed, according to the time constant of the phase compensating circuit.

### SUMMARY OF THE INVENTION

The present invention was developed in view of the above-described problems.

It is an object of the present invention to provide a controlling technique for driving a three-phase brushless motor, which can change phase stator windings of the three-phase brushless motor with keeping a predetermined phase difference to a phase of a back electromagnetic force generated in any one of the phase stator windings, reduce a change of a torque of the three-phase brushless motor, and always keep the most suitable efficiency in driving the three-phase brushless motor, even if a number of rotation of the three-phase brushless motor changes extremely, for example, from a minimum to ten times as large a maximum as the minimum.

According to the present invention, the circuit for driving a three-phase brushless motor comprises a first counter for checking a time of a cycle of a zero cross of a back electromagnetic force detected by a back electromagnetic force detector, and a second counter for counting the time checked by the first counter at a clock having two times as high a frequency as the first counter.

More specifically, in accordance with an aspect of the present invention, an apparatus for driving a multiphase brushless motor comprising a plurality of phase stator windings, by changing a current supplied to each of the phase stator windings, comprises: an output circuit for supplying the current to each of the phase stator windings selectively; a back electromagnetic force detector for detecting a back electromagnetic force induced in one to which the current is not supplied of the phase stator windings, and outputting a detection signal; a control logic circuit for controlling the output circuit on the basis of the detection signal outputted from the back electromagnetic force detector; a timing control circuit for determining a start timing and an end timing of a control signal supplied from the control logic circuit to the output circuit; and a clock generator for generating a clock signal required for the control logic circuit and the timing control circuit, wherein the timing control circuit comprises a first counter circuit for counting a first clock signal generated by the clock generator and checking a time of a cycle of the detection signal outputted from the back electromagnetic force, and a second counter circuit for counting a counter number counted by the first counter circuit according to a second clock signal having two times as high a frequency as the first clock signal, and determines the start timing and the end timing of the control signal supplied from the control logic circuit to the output circuit at a rise timing or a fall timing of an output outputted from the second counter circuit.

According to the apparatus of the aspect of the present invention, because the counter circuits for counting the clock signals generate a phase difference between a zero cross point of the back electromagnetic force and a timing of changing the phase stator windings, in case the counter circuits do not overflow, even if a number of rotation of the multiphase brushless motor is changed, it is possible to obtain the stable phase difference. Consequently, it is possible to realize the noiseless apparatus for driving the multiphase brushless motor, which can reduce a torque ripple and a rotational unevenness of the multiphase brushless motor with keeping the most suitable efficiency in driving the multiphase brushless motor.

Preferably, in the apparatus for driving the multiphase brushless motor, of the aspect of the present invention, the clock generator generates a reference clock signal having at least 100 times as high a frequency as the back electromagnetic force generated in the multiphase brushless motor, and the control logic circuit operates on the basis of the reference clock signal generated by the clock generator.

Accordingly, because the control logic circuit detects a change of a rotational signal based on the detection signal of the back electromagnetic force and generates a series of control signals, and the counter circuits operates on the basis of the control signals, it is possible to reduce a lagging time before a timing signal of changing the phase stator windings is outputted to a negligible extent. Consequently, it is possible to improve a response from the control logic circuit.

Preferably, in the apparatus for driving the multiphase brushless motor, as described above, the control logic circuit controls the output circuit so as to drive each of the phase stator windings according to a full wave of each of the phase stator winding, or the control logic circuit controls the output circuit so as to drive each of the phase stator windings according to a half wave of each of the phase stator winding.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIGS. 1A to 1G are timing charts showing a state signals change when a circuit for driving a three-phase brushless motor rotates the three-phase brushless motor, according to an earlier development;

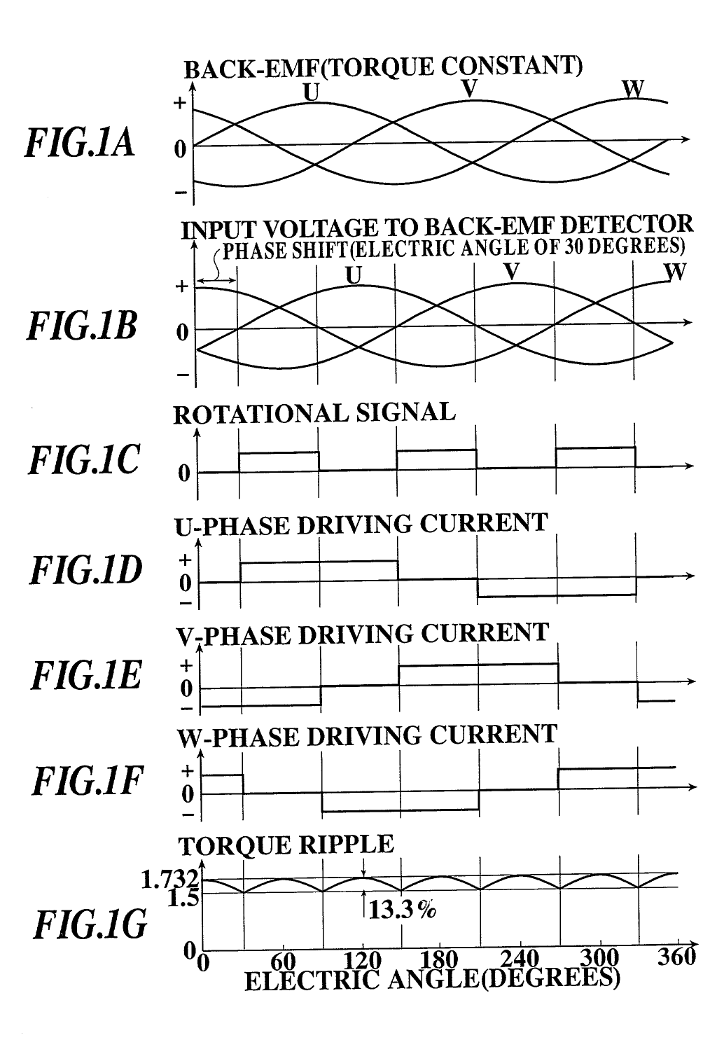

FIGS. 2A to 2G are timing charts showing a state signals change when a number of rotation of the three-phase brushless motor is half one of the three-phase brushless motor rotating at a timing shown in FIGS. 1A to 1G;

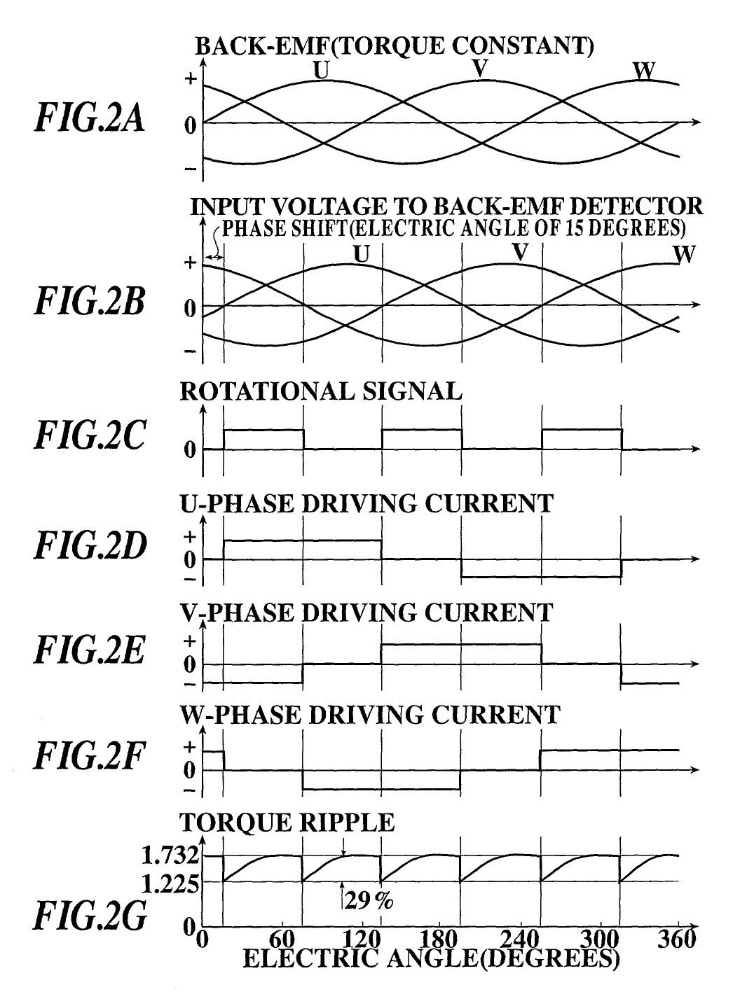

FIGS. 3A to 3G are timing charts showing a state signals changes when another circuit for a three-phase full-wave brushless motor rotates the three-phase full-wave brushless motor, according to an earlier development;

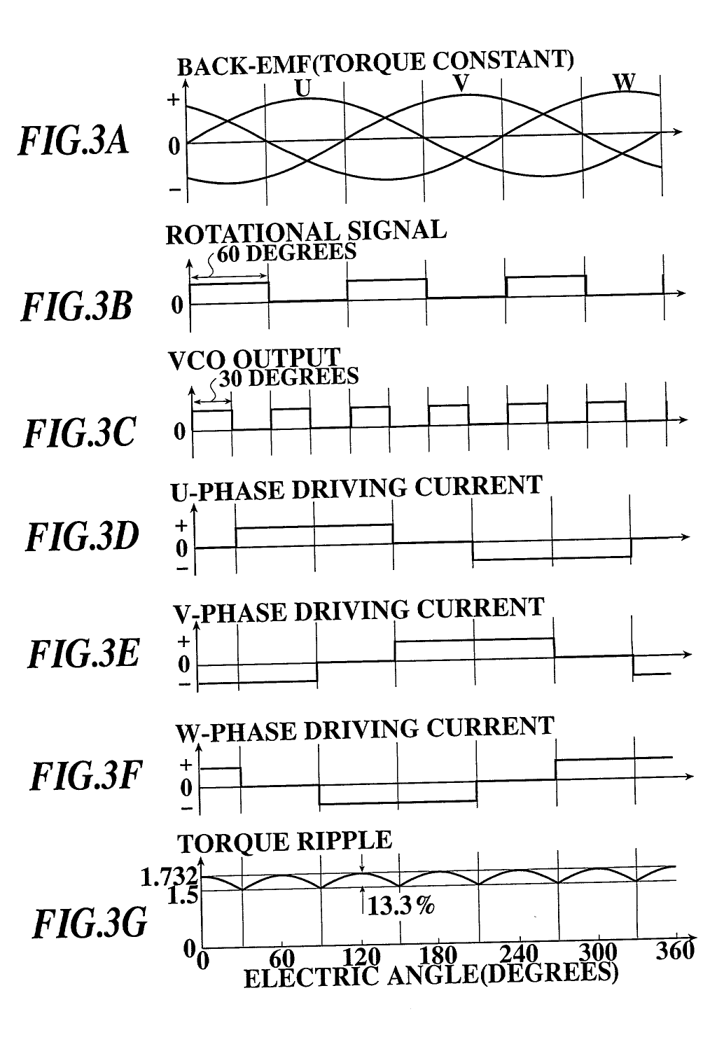

FIG. 4 is a block diagram showing an exemplary construction of an effective circuit for driving a three-phase full-wave brushless motor, to which the present invention is applied;

FIG. 5 is a block diagram showing a clock generator and a timing generator of the circuit shown in FIG. 4;

FIGS. 6A to 6G are timing charts showing a state signals change when a circuit for driving a three-phase full-wave brushless motor, to which the present invention is applied, rotates the three-phase full-wave brushless motor; and

FIGS. 7A to 7G are timing charts showing a state signals change when a circuit for driving a three-phase half-wave brushless motor, to which the present invention is applied, rotates the three-phase half-wave brushless motor.

### PREFERRED EMBODIMENTS OF THE INVENTION

Hereinafter, a preferred embodiment of the present invention will be explained with reference to figures, as follows.

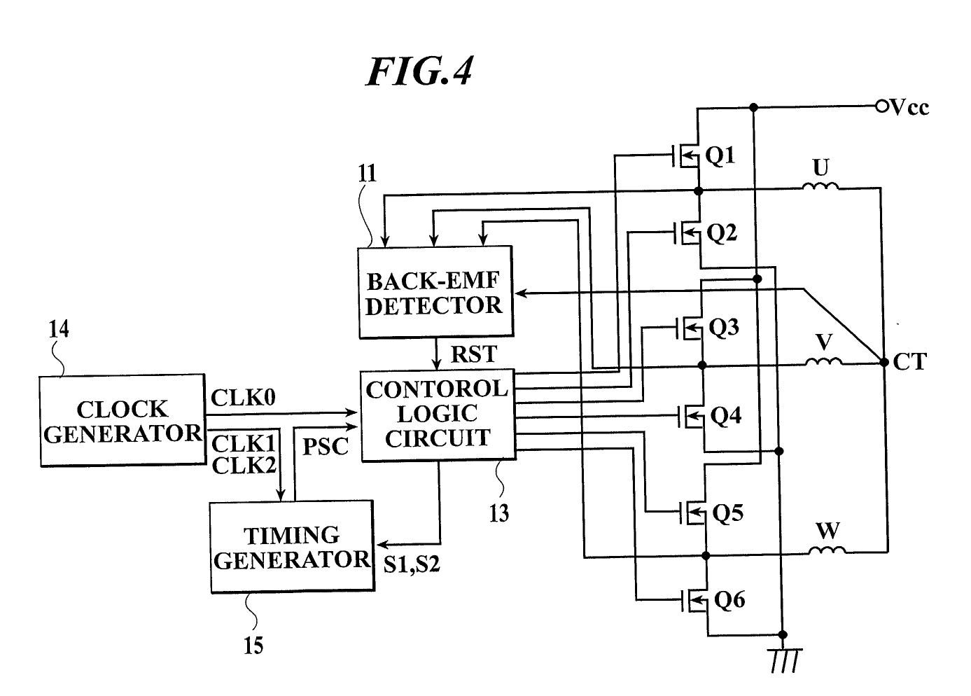

FIG. 4 is a block diagram showing an exemplary construction of an effective circuit for driving a three-phase full-wave drive brushless motor, to which a present invention is applied.

The reference characters “U”, “V” and “W” denote three phase stator windings which are wound on a stator core of the three-phase full-wave drive brushless motor, and “Q1” to “Q6” denote output transistors for supplying a driving current to the U-phase, V-phase and W-phase stator windings. Further, the reference numeral “11” denotes a back-EMF (back electromagnetic force) detector for detecting a position of a rotor magnet of the three-phase full-wave drive brushless motor rotating on the basis of a zero cross point of a back-EMF generated in a non current-carrying phase of the three phase stator windings of the three-phase full-wave drive brushless motor, “13” denotes a control logic circuit for observing and controlling the whole circuit, “14” denotes a clock generator for generating a clock signal required for the control logic circuit 13 of controlling the circuit, and “15” denotes a timing generator for generating a timing signal of changing phases.

The back-EMF detector 11 comprises, for example, three comparators each of which compares a potential of an output terminal to which one terminal of any one of three windings is connected with a potential of a center tap CT to which another terminal of each of the three windings is commonly connected, a trigger type flip flop for inverting an output even when an output outputted from any one of the comparators rises, and so on. Therefore, the back-EMF detector 11 outputs a rotational signal RTS changing from a high level to a low level or from a low level to a high level even at a zero cross timing of the back-EMF generated in any one of the three windings.

Further, for example, in case the circuit shown in FIG. 4 is mounted as a monolithic integrated circuit, a temperature detector for detecting a rise of an unusual temperature of a chip may be provided besides the above-described circuits, as the occasion may demand.

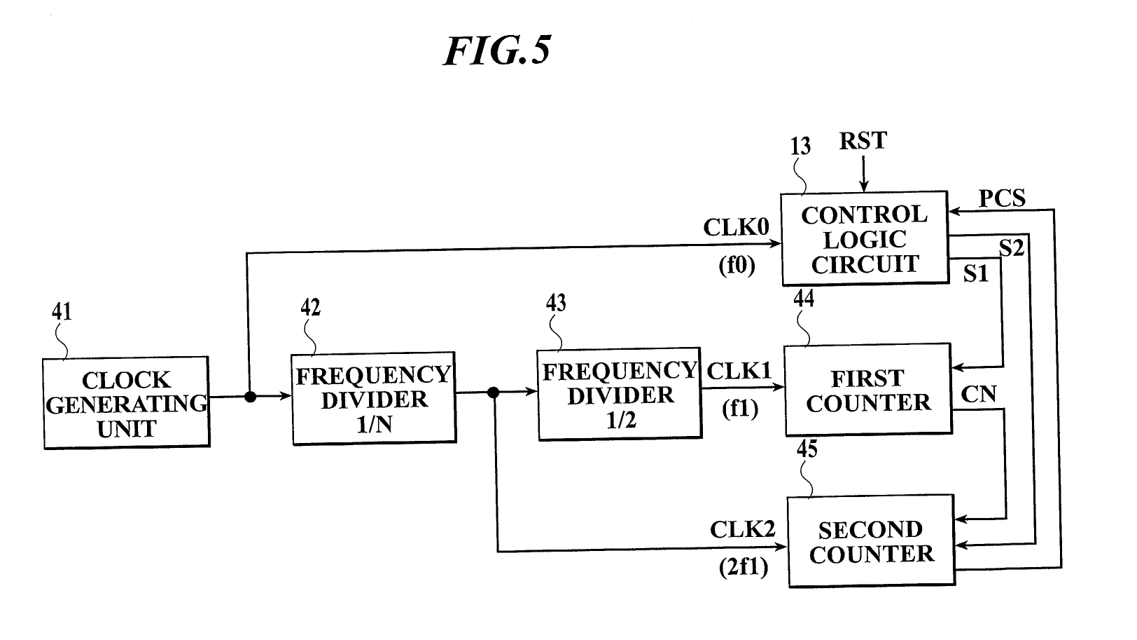

FIG. 5 is a block diagram showing an exemplary construction of the clock generator 14 and the timing generator 15 as described above.

In FIG. 5, the reference numeral “14” denotes a clock generating unit including a oscillator for generating an oscillating signal having a sufficiently higher frequency than a frequency of the back-EMF of the three-phase full-wave drive brushless motor. Further, the reference numeral “42” denotes a frequency divider for dividing a frequency f0 of a clock signal CLK0 generated by the clock generating unit 41, by N which is a positive integral number, and outputting a clock signal CLK2 having a frequency 2f1, and “43” denotes a frequency divider for further dividing the frequency 2f1 of the clock signal CLK2 divided by the frequency divider 42, by 2, and outputting a clock signal CLK1 having a frequency f1. Therefore, the clock generator 14 comprises the clock generating unit 41, and the frequency dividers 42 and 43.

Further, the reference numeral “44” denotes a first counter for counting the clock signal CLK1 having the frequency f1, outputted from the frequency divider 43, and “45” denotes a second counter for counting the clock signal CLK2 having the frequency 2f1, outputted from the frequency divider 42. Therefore, the timing generator 15 comprises the first counter 44 and the second counter 45.

Herein, the frequency f0 of the CLK0 is determined so as to be sufficiently higher than the frequency 2f1 of the CLK2, for example, so that the frequency dividing ratio N of the frequency divider 42 is more than 10.

The clock signal CLK0 generated by the clock generating unit 41 of the clock generator 14 is supplied to not only the frequency divider 42 but also the control logic circuit 13 as a operation clock signal.

The first counter 44 and the second counter 45 have the same bit numbers as each other, and counts according to an instruction of the control logic circuit 13. For example, the first counter 44 comprises an up counter circuit, and the second counter 45 comprises a down counter circuit. For example, the second counter 45 outputs a high level signal while counting the clock signal CLK2, and outputs a low level signal when finishing counting the clock signal CLK2, that is, when the result of counting is 0.

Hereinafter, the motion of the three-phase full-wave drive brushless motor driven by the circuit having the above-described construction, according to the embodiment will be explained.

The back-EMF detector 12 detects the zero cross timing of the back-EMF generated in the non current-carrying phase, generates the rotational signal RTS having a cycle which is an electric angle of 120 degrees within the range of which the rotational signal RTS changes from the high level to the low level and after from the low level to the high level even at the detected zero cross timing of the back-EMF generated in the non current-carrying phase, and outputs the rotational signal RTS to the control logic circuit 13.

Then, the control logic circuit 13 outputs the following control signals S1 and S2 to the first counter 44 and the second counter 45 respectively, even when the rotational signal RTS rises up or falls down.

When the first counter 44 receives the control signal S1 outputted from the control logic circuit 13, the first counter 44 stops counting the CLK1. Then, the first counter 44 outputs the counter number CN to the second counter 45, and resets the counter number CN. Thereafter, the first counter 44 and the second counter 45 start counting the CLK1 and the CLK2, respectively. The first counter 44 and the second counter 45 performs the above-processing even when the rotational signal RTS rises up or falls down, continuously.

The first counter 44 is an up counter. Further, because the first counter 44 resets the counter number CN continuously even when the rotational signal RTS rises up or falls down, the first counter 44 checks the time of the half cycle of the rotational signal RTS, that is, the time corresponding to the electric angle of 60 degrees. On the other hand, the second counter 45 is a down counter. Further, because the second counter 45 counts the clock signal CLK2 having two times as high the frequency as the clock signal CLK1 counted by the first counter 44, the second counter 45 checks the time which is ½ of the half cycle of the rotational signal RTS, that is, the time corresponding to the electric angle of 30 degrees.

Then, when the second counter 45 supplies the count up signal to the control logic circuit 13, as a phase changing timing signal PCS, the control logic circuit 13 controls the direction of the current supplied to each phase, according to the phase changing timing signal PCS.

According to the embodiment, the accuracy of the phase shift from the zero cross timing of the back-EMF to the phase changing timing is dependent on the bit numbers of the first counter 44 and the second counter 45. Therefore, for example, if the accuracy is required within the range of ±3 degrees, at least 5-bit counter circuit is used as the first counter 44 and the second first counter 45.

On the other hand, because the frequency of the clock CLK0 inputted to the control logic circuit 13 from the clock generator 14 is determined to be more than 100 times as high the frequency as the rotational signal RTS, the time required for the control logic circuit 13 of detecting the change of the rotational signal RTS and generating a series of control signals is extremely shorter than the frequency of the rotational signal RTS, that is, the time is about 4% of the frequency of the rotational signal RTS. Accordingly, the lagging time before the control logic circuit 13 detects the change of the rotational signal RTS and generates a series of control signals and the counter circuits 44 and 45 perform on the basis of the control signals and output the phase changing timing signal is within a negligibly time substantially.

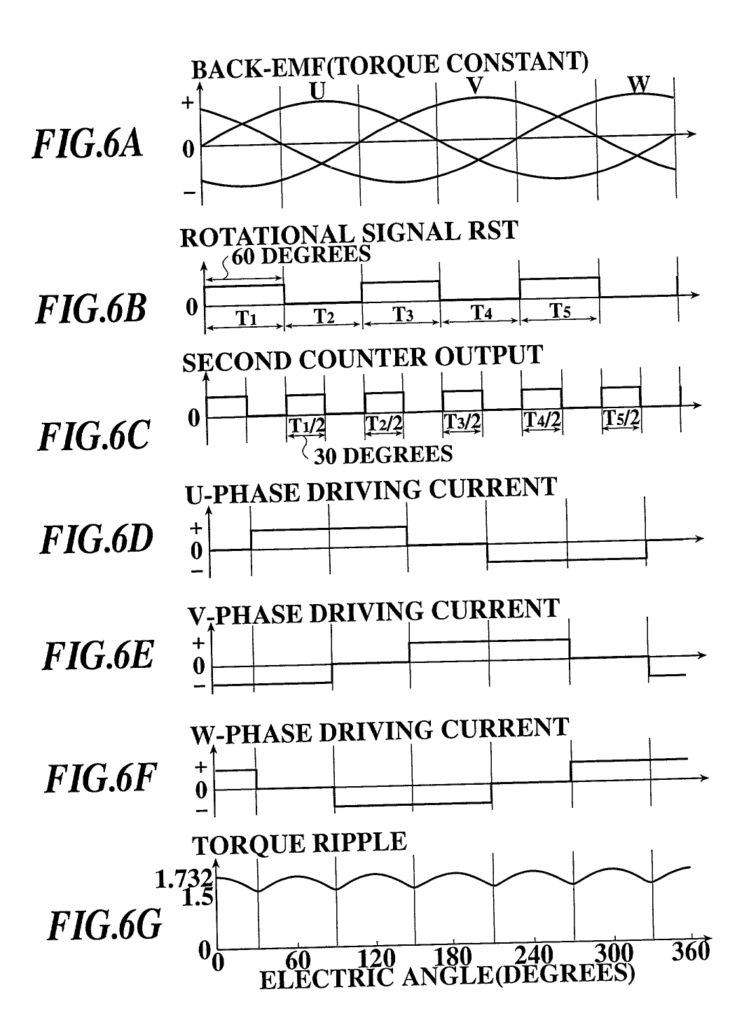

FIGS. 6A to 6G are timing charts showing a case the present invention is applied to the circuit for driving the three-phase full-wave brushless motor, and the circuit rotates the three-phase full-wave brushless motor.

FIG. 6A is a timing chart showing back-EMFs generated in the U-phase, V-phase and W-phase stator windings of the three-phase full-wave brushless motor. FIG. 6B is a timing chart showing the rotational signal RTS outputted from the back-EMF detector 12. FIG. 6C is a timing chart showing the output outputted from the second counter 45. FIGS. 6D to 6F are timing charts showing currents for driving the U-phase, V-phase and W-phase respectively. FIG. 6G is a timing chart showing the torque ripple generated in the three-phase full-wave brushless motor.

The first counter 44 checks the time of the half cycle of the rotational signal RST. Then, the second counter 45 checks the time of the half time checked by the first counter 44, in the next half of the cycle of the rotational signal RST. Therefore, the timing at the electric angle of 30 degrees can be extracted without lagging from the zero cross timing of the back-EMF substantially. Accordingly, it is possible to ideally drive the three-phase full-wave drive brushless motor with always keeping the small torque ripple, in case the number of rotation changes every moment.

According to the embodiment, the phase difference between the zero cross timing of the back-EMF and the phase changing timing is determined on the basis of the ratio of the frequency of the clock inputted to the first counter 44 to the frequency of the clock inputted to the second counter 45. Therefore, the phase difference has nothing to do with the number of rotation of the motor. Accordingly, because the time constant is not used in the circuit, there does not occur the problem about the following. Further, in case the counter circuits 44 and 45 do not overflow, the phase difference does not change. Accordingly, if the circuit is designed so that the counter circuits 44 and 45 do not overflow within the range of the determined number of rotation, it is possible to ideally drive the three-phase full-wave drive brushless motor with keeping the small torque ripple within the range of all the number of rotation.

Further, even if the absolute value of the frequency of the clock is uneven, in case the ratio of the frequencies of the clocks inputted to the counters is not shifted, the determined phase shift is kept. Accordingly, it is easy to incorporate the clock generator in the integrated circuit.

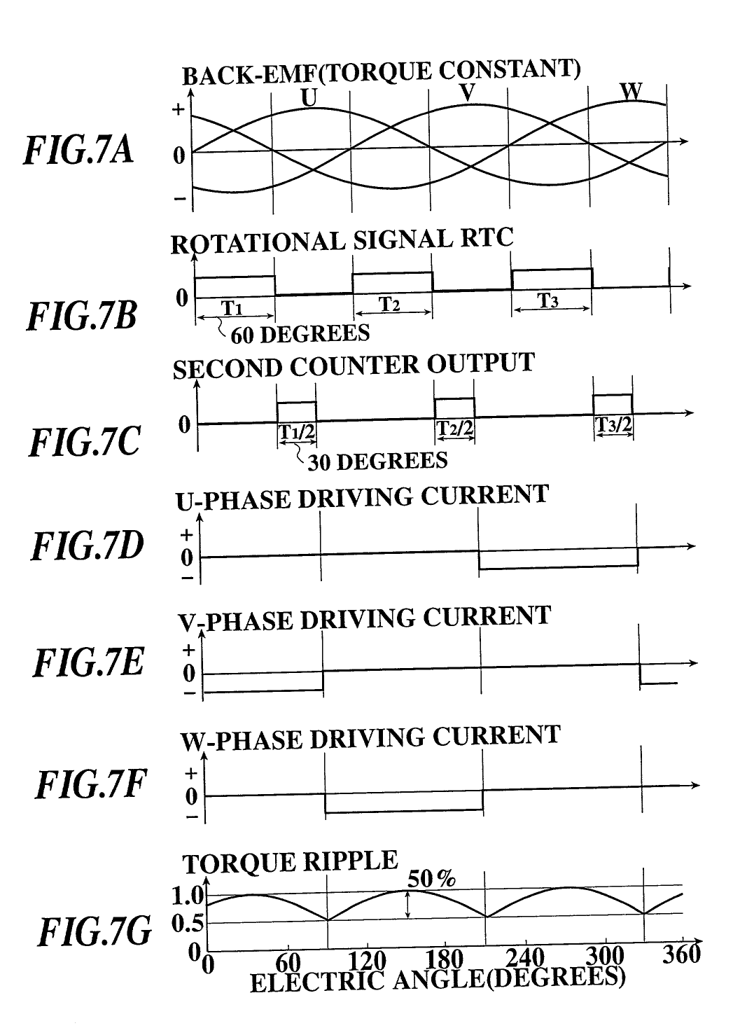

FIGS. 7A to 7G are timing charts showing a case the present invention is applied to a circuit for driving a three-phase half-wave brushless motor, and the circuit rotates the three-phase half-wave brushless motor.

The circuit for driving the three-phase half-wave brushless motor has the construction wherein the output transistors Q1, Q3 and Q5 or the output transistors Q2, Q4 and Q6 are omitted from the circuit shown in FIG. 4, and the center tap CT is connected to the power supply voltage Vcc or the ground potential. Therefore, it is omitted to show the circuit for driving the three-phase half-wave brushless motor in figures.

In the circuit for driving the three-phase half-wave brushless motor, only when the back-EMF is positive or negative, the current is supplied to windings.

FIGS. 7A to 7G are an exemplary case the current is supplied to the windings when the back-EMF is negative.

According to the embodiment as well as one shown in FIGS. 6A to 6G, the first counter 44 counts up the half time of the cycle of the rotational signal RTS, and the second counter 45 counts down the half time of the time counted by the first counter 44 in the next half of the cycle. Therefore, the phase is changed at the timing of the counter number “0” counted by the second counter 45. Accordingly, even if the number of rotation is changed, it is possible to reduce the torque ripple generated in the three-phase half-wave brushless motor.

Although the present invention has been explained according to the above-described embodiment, it should also be understood that the present invention is not limited to the embodiment and various chanted and modifications may be made to the invention without departing from the gist thereof.

According to the present invention, the following effects will be indicated.

The circuit can change phase stator windings of the multiphase brushless motor with keeping the predetermined phase difference to the phase of the back electromagnetic force generated in any one of the phase stator windings, even if the number of rotation of the multiphase brushless motor changes extremely. Consequently, it is possible to realize the circuit for driving the multiphase brushless motor, which can reduce the change of the torque of the multiphase brushless motor, and always keep the most suitable efficiency in driving the multiphase brushless motor.

Herein, the technique for controlling the brushless motor according to the present invention can be applied to not only the three-phase brushless motor but also a two-phase full-wave drive brushless motor.

The entire disclosure of Japanese Patent Application No. Tokugan 2001-172513 filed on Jun. 7, 2001 including specification, claims, drawings and summary are incorporated herein by reference in its entirety.

What is claimed is:

1. An apparatus for driving a multiphase brushless motor comprising a plurality of phase stator windings, by changing a current supplied to each of the phase stator windings, the apparatus comprising:
an output circuit for supplying the current to each of the phase stator windings selectively;
a back electromagnetic force detector for detecting a back electromagnetic force induced in one to which the current is not supplied of the phase stator windings, and outputting a detection signal;
a control logic circuit for controlling the output circuit on the basis of the detection signal outputted from the back electromagnetic force detector;
a timing control circuit for determining a start timing and an end timing of a control signal supplied from the control logic circuit to the output circuit; and
a clock generator for generating a clock signal required for the control logic circuit and the timing control circuit,
wherein the timing control circuit comprises a first counter circuit for counting a first clock signal generated by the clock generator and checking a time of a cycle of the detection signal outputted from the back electromagnetic force, and a second counter circuit for counting a counter number counted by the first counter circuit according to a second clock signal having two times as high a frequency as the first clock signal, and determines the start timing and the end timing of the control signal supplied from the control logic circuit to the output circuit at a rise timing or a fall timing of an output outputted from the second counter circuit.

2. The apparatus for driving the multiphase brushless motor, as claimed in claim 1,
wherein the clock generator generates a reference clock signal having at least 100 times as high a frequency as the back electromagnetic force generated in the multiphase brushless motor, and
the control logic circuit operates on the basis of the reference clock signal generated by the clock generator.

3. The apparatus for driving the multiphase brushless motor, as claimed in any one of claims 1 and 2,
wherein the control logic circuit controls the output circuit so as to drive each of the phase stator windings according to a full wave of each of the phase stator winding.

4. The apparatus for driving the multiphase brushless motor, as claimed in any one of claims 1 and 2,
wherein the control logic circuit controls the output circuit so as to drive each of the phase stator windings according to a half wave of each of the phase stator winding.
